(19) United States
(12) Patent Application Publication
(10) Pub. No.: US 2003/0177049 A1
(43) Pub. Date: Sep. 18, 2003

(54) Skill matching information providing method

(75) Inventors: Kazuaki Honda, Ota (JP); Hiroshi Kuzumaki, Ota (JP); Akio Fujino, Ota (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 10/282,086

(22) Filed: Oct. 29, 2002

(30) Foreign Application Priority Data
Mar. 15, 2002 (JP) 2002-071522

(51) Int. Cl. G06F 17/60

(52) U.S. Cl. 705/8

(57) ABSTRACT

A server machine obtains information about skills actually held by workers in a company from a client machine of the company. The server machine analyzes surplus and deficiency of person in each skill field based on the obtained information. Further, the server machine finds the condition to solve the surplus and deficiency of person based on the analyzed result. Specifically, skill matching information, which shows an organization-to-organization personnel transfer and learning courses that should be attended by the workers, is created. The skill matching information is transmitted to the client machine and displayed on a screen to inform a person in charge in the company.

### BACKGROUND OF THE INVENTION

1. Field of the Invention

The present invention relates to a skill matching information providing method for providing information to be used to match actual skills of workers to skills required in an organization such as a company or a department of a company so that the organization can keep required number of workers with the required skills.

2. Prior Art

In late years, technical innovation and social change cause the situation in which a skill required before has been unimportant and another skill has been important in an organization such as a company or a department of a company with increasing frequency. Therefore, a number of workers with the a presently required skill can be running short in each organization.

On the other hand, the workers with a predetermined skill can be surplus. Accordingly, actual skills of workers should be matched to the required skills in an organization with personnel transfer among organizations in view in order to make full use of the skills that have been already held by the workers.

### SUMMARY OF THE INVENTION

It is therefore an object of the present invention to provide an improved skill matching information providing method, which is capable of analyzing deficiency and/or surplus of an actual skill in an organization and providing skill matching information to be used for drafting a skill matching plan for satisfying the condition of skills required in the organization.

A first aspect of a skill matching method according to the present invention is executed by a computer that includes a storage in which information about education to obtain a skill is stored. The method includes a comparing step for comparing information about skills actually held by respective workers in an organization with information about a number of workers with skills required in the organization, and an output step for outputting information about an education plan of the workers belonging to the organization based on the result of the comparing step and the information about education to obtain a skill.

With this method, a skill that is deficient in the organization becomes clear and the education plan to supplement the deficiency in the organization can be drafted. Education according to the plan solves the deficiency of a skill. The organization may be a company or a department in a company. Further, the computer may be a single computer machine or a distributed computer system that consists of a network of a plurality of computer machines. The storage may be a register, a temporary memory or a hard disk or the like.

Information about a plural fields of skills actually held by respective workers in the organization and information about numbers of workers with respective skills required in the organization may be compared at the comparing step.

The information about numbers of workers with respective skills required in an organization may be found by comparing information about skills actually held by workers in the organization with information about skills actually held by workers in another organization.

A second aspect of a skill matching method according to the present invention is executed by a computer to extract candidates in a second organization to be transferred to a first organization. The method includes a comparing step for comparing information about skills actually held by respective workers in the first organization with information about a number of workers with skills required in the first organization, and an output step for outputting information of candidates to be transferred from the second organization to the first organization based on the result of the comparing step and information about skills actually held by respective workers in the second organization,

The candidates may be extracted from workers in the second organization except the workers allocated with transfer prohibited information, which is stored in a storage of the computer, in the output step.

A third aspect of a skill matching method according to the present invention is executed by a computer and includes a comparing step comparing information about skills actually held by respective workers in a first organization with information about a number of workers with skills required in the first organization, a selecting step for selecting candidates to be educated to acquire the skills from workers in the first organization and a second organization based on the result of the comparing step and information about skills actually held by respective workers in the first and second organizations, and an output step for outputting information with respect to personnel transfer of the candidates selected at the selecting step to the first organization from the second organization and an education plan for workers in the second organization.

### DESCRIPTION OF THE ACCOMPANYING DRAWINGS

FIG. 1 is a block diagram showing the entire configuration of a skill matching plan drafting system of an embodiment according to the present invention;

FIG. 2 shows a data layout of a skill-by-company DB;

FIG. 3 shows a data layout of a counting table;

FIG. 4 shows a flowchart showing the process executed in the embodiment;

FIG. 5 shows a data layout of a holding skill table;

FIG. 6 shows a data layout of a skill-by-department table;

FIG. 7 shows a data layout of a surplus/deficiency table;

FIG. 8 shows a data layout of a upskilling table;

FIG. 9 is a flowchart showing the process for creating the upskilling table;

FIG. 10 shows a data layout of a learning course table;

FIG. 11 shows a data layout of an optimum condition without personnel transfer table;

FIG. 12 shows a data layout of an optimum condition with personnel transfer table; and

FIG. 13 shows one example of a frame showing a training plan.

### DESCRIPTION OF THE PREFERRED EMBODIMENTS

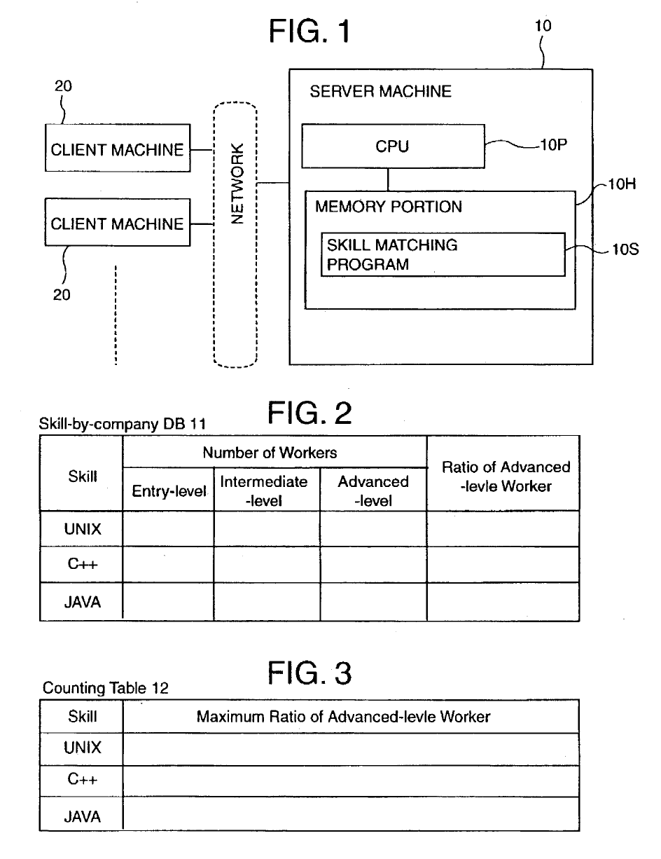

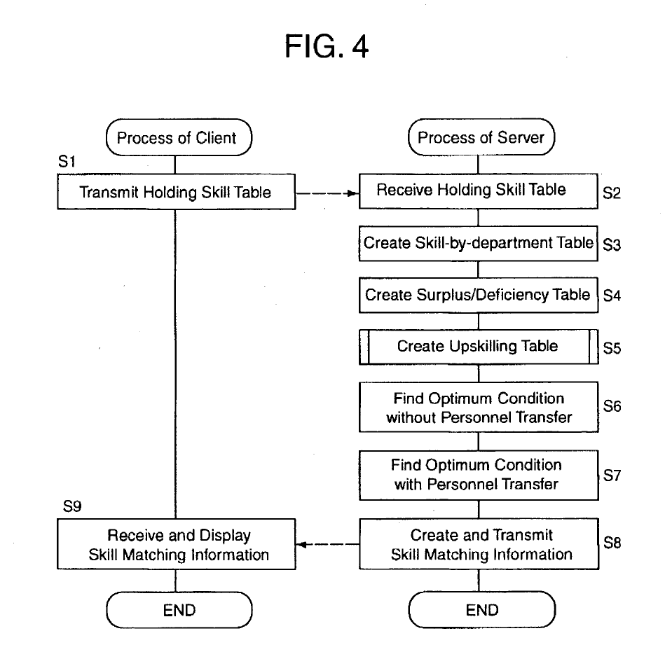

An embodiment of the present invention will be described with reference to the drawings. FIG. 1 is a block diagram of the entire system including a server machine 10 as a skill matching system of the embodiment. The server machine 10 is a server computer that can connect to client machines 20 of a plurality of companies through a network such as the Internet and provides skill matching information, which will be described below with reference to FIG. 4, in response to request from the companies.

The server machine 10 is provided with a CPU 10P and a memory portion (storage) 10H having a hard disk and a memory that are connected to the CPU 10P. A skill matching program 10S is installed in the memory portion 10H. The skill matching program 10S includes a Web server program module, a server side program module and a program module to execute a skill matching process described below.

For example, the client machine 20 consists of a personal computer in which a Web browser program is installed. A person in charge in a company accesses the server machine 10 from the client machine 20 to transmit information with respect to the skills of its workers. The server machine 10 obtains the information transmitted from the client machine 20 and stores it into the memory portion 10H. Specifically, the information with respect to the skills in one company is stored as one record in a skill-by-company DB shown in FIG. 2.

In records of the skill-by-company DB 11, a number of workers with an “Entry-level” skill, a number of workers with an “Intermediate-level” skill and a number of workers with an “Advanced-level” skill are stored for each of fields of skill. Further, “Rate of Advanced-level Worker” that indicates a ratio of the number of “Advanced-level” workers to the total number of workers is stored for each field of skill. In FIG. 2, “UNIX”, which is a trademark of the Open group registered in United States and other countries and is simply called as “UNIX” in the following description, “C++” and “JAVA”, which is trademark of Sum Microsystems, Inc., are shown as the fields of skill for example. Other various skill fields such as database and project management may be set as the fields of skill.

In the skill-by-company DB11, in fact, a plurality of records corresponding to a plurality of companies are stored. The server machine 10 refers to all the records of the skill-by-company DB 11 to find the maximum value of the “Ratio of Advanced-level Worker” for each field of skill and creates a counting table 12 shown in FIG. 3. The maximum values of the “Ratio of Advanced-level Worker” for each field of skill are stored into a field of “Maximum Ratio of Advanced-level worker” in the counting table 12. The “Maximum Ratio of Advanced-level Worker” is used as valuation standard. The counting table 12 may store an average value of the “Ratio of Advanced-level Worker” for each field of skill for all companies. The server machine 10 can analyze the deficiency of skill in each company as described in U.S. patent application 20020062242.

Furthermore, the server machine 10 can analyze the condition of skills of workers in each department of each company to create skill matching information for planing a skill matching plan with relocation of workers in view. A person in charge in a company accesses the server machine 10 from the client machine 20 to transmit information with respect to the skills of its workers of the respective department to the server machine 10 for requesting the server machine 10 to create skill matching information. Hereinafter, a process for creating the skill matching information will be described with reference to the flowchart shown in FIG. 4.

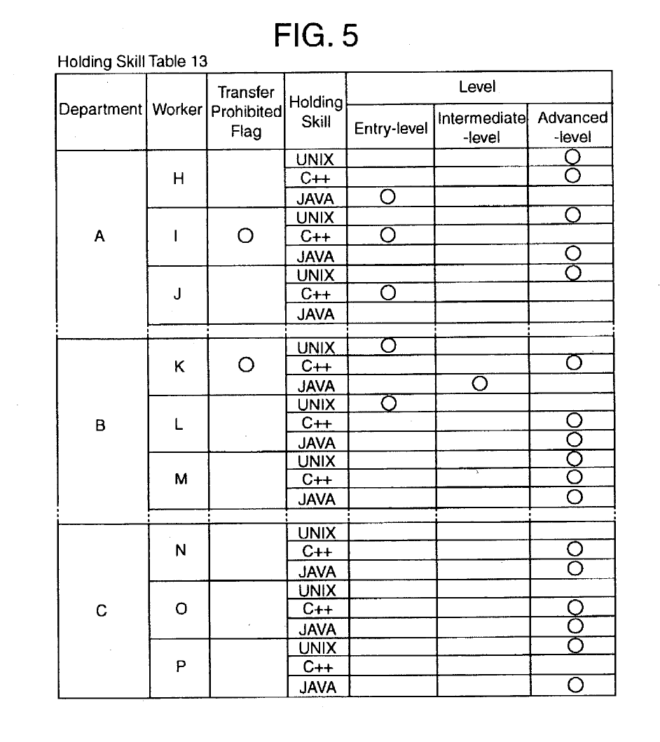

The client machine 20 of the company summarizes the information with respect to the skills of workers belonging to the respective departments of the company in a holding skill table 13 shown in FIG. 5 and transmits the information to the server machine 10 (S1). In the holding skill table 13, levels of actual skills of workers belonging to the respective departments of the company are summarized. The levels of a skill are classified into entry-level, intermediate-level and advanced-level. For instance, the worker “H” belonging in the department “A” has “Advanced-level” in “C++” and “UNIX” and has “Entry-level” in “JAVA”. Further, “Transfer Prohibited Flag” is set in this holding skill table 13. The “Transfer Prohibited Flag” is set to workers who are too important for the department to transfer to another department. For instance, since the worker “I” belonging in the department “A” is an essential person in the department, the “Transfer Prohibited Flag” is on.

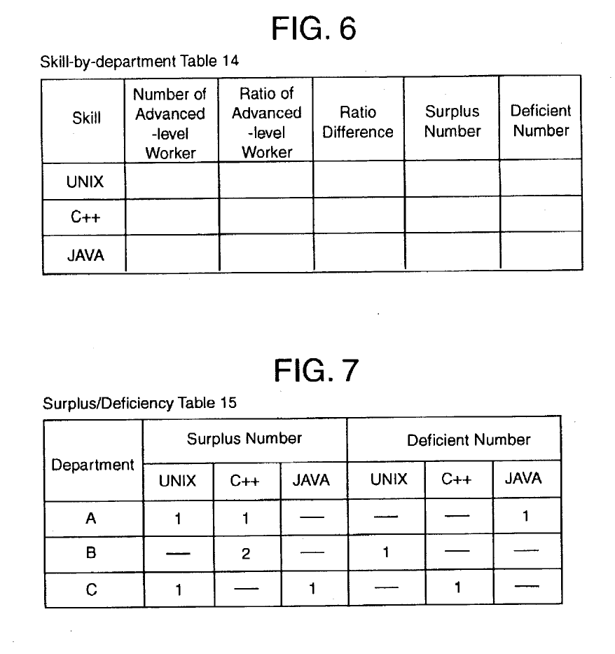

The server machine 10 receives the holding skill table 13 transmitted at S1 (S2) and creates a skill-by-department table 14 shown in FIG. 6 based on the holding skill table 13. The skill-by-department table 14 is stored in the memory portion 10H (S3).

The skill-by-department table 14 is created for each department of the company. More specifically, the server machine 10 finds “Number of Advanced-level Worker” by counting a number of workers with the advanced-level skill for each skill field of each department registered in the holding skill table 13. After that, the server machine 10 calculates “Ratio of Advanced-level Worker” that is a ratio of the workers with the advanced-level skill to the total number of workers in the department for each skill field of each department. The “Ratio of Advanced-level Worker” is used as valuation value.

Further, the server machine 10 refers to the counting table 12 (FIG. 3) to calculate “Ratio Difference” that is a difference between “Maximum Ratio of Advanced-level Worker” and “Ratio of Advanced-level Worker” (FIG. 6). When “Ratio of Advanced-level Worker” of the current department is smaller than “Maximum Ratio of Advanced-level Worker”, the server machine 10 calculates “Deficient Number” that is the number of workers with the advanced-level skill required to increase “Ratio of Advanced-level Worker” of the current department to “Maximum Ratio of Advanced-level Worker”. When “Ratio of Advanced-level Worker” of the current department is larger than “Maximum Ratio of Advanced-level Worker”, the server machine 10 calculates “Surplus Number” that is the number of workers with the advanced-level skill required to decrease “Ratio of Advanced-level Worker” of the current department to “Maximum Ratio of Advanced-level Worker”. “Number of Advanced-level Worker”, “Ratio of Advanced-level Worker”, “Ratio Difference”, “Deficient Number” and “Surplus Number” found through the above described method a resummarized in the skill-by-department table 14.

Then the server machine 10 creates a surplus/deficiency table 15 shown in FIG. 7 based on the skill-by-department table 14 created and stored at S3 and stores it into the memory portion 10H (S4). More specifically, the server machine 10 refers to “Deficient Number” and “Surplus Number” in the skill-by-department table 14 to summarize “Deficient Number” and “Surplus Number” in each skill field of each department in the surplus/deficiency table 15. For instance, as shown in FIG. 7, the surplus numbers for “UNIX” and “C++” are equal to “1” in the department “A”. On the other hand, the surplus number for “C++” is equal to “2” and the deficient number for “UNIX” is equal to “1” in the department “B”.

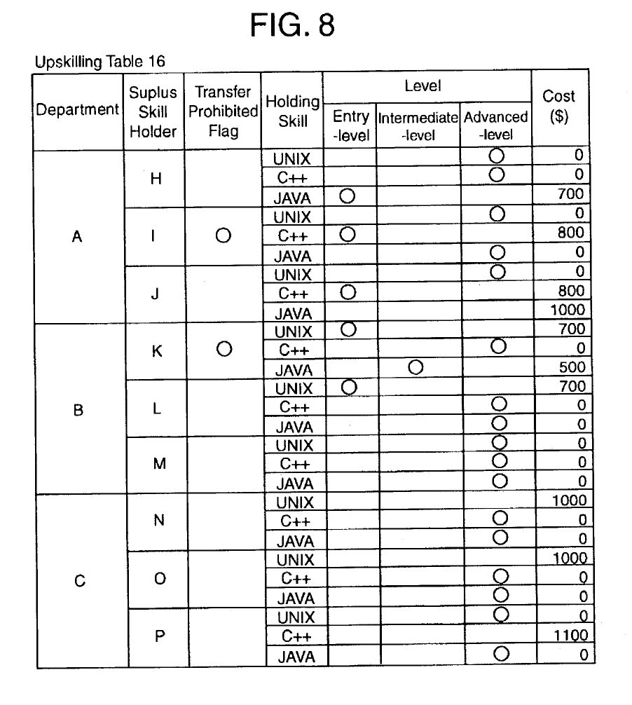

Next, the server machine 10 calculates the cost required to make the workers with the skill that is surplus in the current department (a surplus skill holder) acquire another skill. Further the server machine 10 creates an upskilling table 16 shown in FIG. 8 and stores it in the memory portion 10H (S5). The upskilling table 16 may contain a period of time.

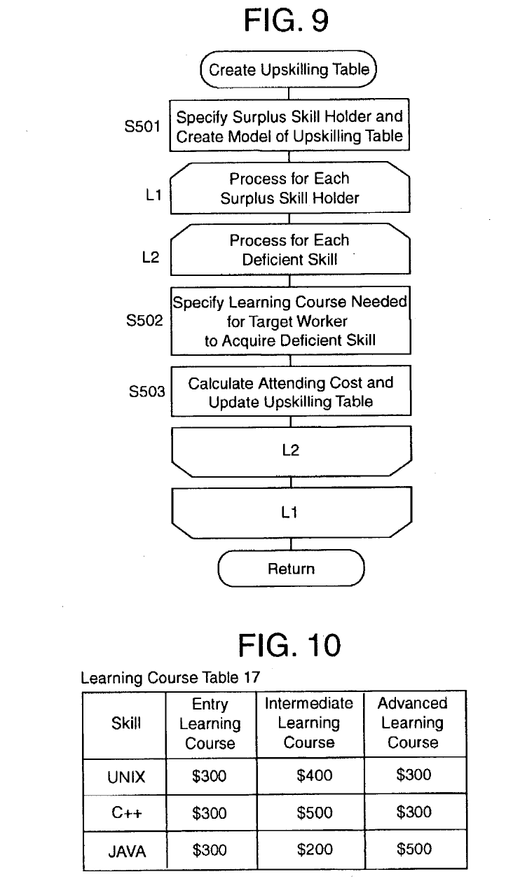

The process for creating the upskilling table 16 (S5 in FIG. 4) will be described in detail with reference to the flowchart shown in FIG. 9.

The server machine 10 refers to the holding skill table 13 (FIG. 5) and the surplus/deficiency table 15 (FIG. 7) to specify the workers who hold the skill and are counted in a surplus skill in the current department (a surplus skill holder) for each department. Then the server machine 10 extracts information with respect to the specified surplus skill holders from the holding skill table 13 to create a model of the upskilling table 16 (FIG. 8) at S501. At the present stage, the column of “Cost” in the model is blank.

Next, the server machine 10 executes the process of a first loop L1 for each of the surplus skill holders specified at S501. In the first loop L1, the server machine 10 executes the process of a second loop L2 for each skill field in which the target surplus skill holder (target worker) has not yet acquired the advanced-level skill (a deficient skill field).

In the second loop L2, the server machine 10 specifies learning courses that are needed for the target worker to acquire the advanced-level skill in the deficient skill field (S502). For instance, the worker “H” in the department “All has only the entry-level skill in the field of “JAVA” as shown in the holding skill table 13 of FIG. 5. Accordingly, the worker “H” has to attend an intermediate learning course that is needed to acquire the intermediate-level skill and an advanced learning course that is needed to acquire the advanced-level skill in order to acquire the advanced-level skill in the field of “JAVA”. Namely, when the target worker is “H” and the deficient skill is “JAVA”, the intermediate course and the advanced course of JAVA are specified at S502.

The server machine 10 finds the cost required to attend the learning course specified at S502 and updates the upskilling table 16 (S503). More specifically, the server machine 10 refers to a learning course table 17 (FIG. 10) that has stored in the memory portion 10H to find the cost required to attend the specified learning courses. Further, the period of time that is needed to attend the specified learning courses may be found. For instance, when the target worker is “H” and the deficient skill is “JAVA”, the server machine 10 calculates the sum ($700) of the cost of the intermediate learning course ($200) and the cost of the advanced learning course ($500) as the cost required for upskilling and stores it into the “Cost” field of the upskilling table of FIG. 8.

When the processes at S502 and S503 for the current deficient skill of the current target worker are finished, the second loop L2 for the current deficient skill is finished and the second loop L2 for the next deficient skill of the current target worker will be executed. Further, when the processes for all the deficient skills of the current target worker are finished, the first loop L1 for the next target worker is executed in the same manner. When the process for all the target workers are finished, the upskilling table 16 is completed and the process in the flowchart of FIG. 9 is finished.

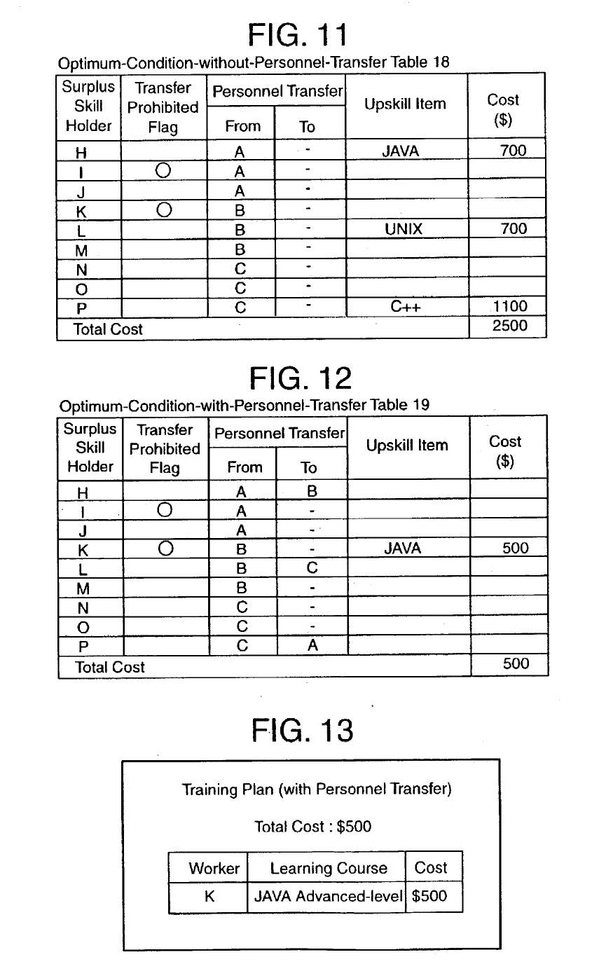

After finishing the process in the flowchart of FIG. 9 (the process at S5 in FIG. 4), the server machine 10 finds an optimum condition of the skill matching under the condition in which workers in the respective departments are not transferred (S6). More specifically, the server machine 10 refers to the upskilling table 16 to select the condition with minimum cost as the optimum condition in consideration of the cost required for the workers to attend the learning courses among all possible conditions for increasing the “Ratio of Advanced-level Worker” to the “Maximum Ratio of Advanced-level Worker” for each skill field in each department without personnel transfer. Further, the server machine 10 summarizes the selected optimum condition in an optimum-condition-without-personnel-transfer table 18 as shown in FIG. 11.

FIG. 11 shows that the skill can be matched, i.e., the optimum condition can be obtained, by making the surplus skill holders “H”, “L” and “P”, acquire the advanced-level skill of “JAVA”, “UNIX” and “C++”, respectively. In this case, the skill matching costs $2500.

Next, the server machine 10 finds an optimum condition of the skill matching in consideration of personnel transfer (S7). Namely, the server machine 10 refers to the upskilling table 16 to select the condition with minimum cost as the optimum condition among all possible conditions for increasing the “Ratio of Advanced-level Worker” to the “Maximum Ratio of Advanced-level Worker” for each skill field in each department, in consideration of the cost required for the workers to attend the learning courses and the cost required for department-to-department personnel transfer. However, the server machine 10 excludes the transfer of the worker whose “Transfer Prohibited Flag” is on from those possible conditions when the server machine 10 finds the optimum condition. Further, the server machine 10 summarizes the selected optimum condition in an optimum-condition-with-personnel-transfer table 19 as shown in FIG. 12.

FIG. 12 shows that the skill can be matched, i.e., the optimum condition can be obtained, by transferring the surplus skill holder “H” from the department “A” to the department “B”, transferring the surplus skill holder “L” from the department “B” to the department “C”, transferring the surplus skill holder “P” from the department “C” to the department “A” and making the surplus skill holder “K” acquire the advanced-level skill of “JAVA”. The skill matching costs $500.

If the calculation amount at S6 and S7 may become too large to be processed by the server machine 10, a genetic algorithm is available for the processes at S6 and S7.

The server machine 10 creates skill matching information including contents of the optimum-condition-without-personnel-transfer table 18 created at S6 and the optimum-condition-with-personnel-transfer table 19 created at S7 and transmits the skill matching information to the client machine 20 (S8).

After the information is transmitted, the server machine 10 finishes its operation. The client machine 20 receives the skill matching information to display contents equivalent to the optimum condition tables 18 and 19 (S9). Then the client machine 20 finishes its operation. The client machine 20 may display either of the optimum condition tables 18 and 19 that is lower at cost. Further, the client machine 20 may display a frame of a training plan shown in FIG. 13 in addition to the skill matching information. The frame of FIG. 13 shows that the worker “K”, should attend the advanced learning course of “JAVA” and it costs $500.

A person in charge in the company sees the contents displayed on the client machine 20 and able to settle on an attending plan of learning courses by workers and a personnel transfer plan among the departments. Execution of the settled plans equates the “Ratio of Advanced-level Worker” of the respective departments in the company with the “Maximum Ratio of Advanced-level Worker”. That is, the workers are educated and relocated with the minimum cost.

While the optimum condition for the education and relocation of the workers is determined so that the cost becomes minimum in the above described embodiment, the optimum condition may be determined so that the period of time becomes minimum. The later approach is effective when the immediate upskilling to the same level as other companies is required regardless of cost. Further, a point of compromise between the cost and the period may be found to show or the both of them may be shown so that the person in charge can select one of them.

The process at S5 in FIG. 4 corresponds to the comparing step for comparing information abut skills held by respective workers with information about a number of workers with skills required.

The process at S6 in FIG. 4 corresponds to the outputting step for outputting information of an education plan of the workers.

The process at S7 in FIG. 4 corresponds to both of the first outputting step for outputting information of an education plan of the workers and the second outputting step for outputting information of candidates to be transferred.

As described above, the skill matching information providing method of the present invention can provide skill matching information to be used for settling a skill matching plan according to which the deficiency of the worker with required skill is filled up and skill of surplus skill holders is effectively used.

What is claimed is:

1. A skill matching information providing method with a computer that includes a storage in which information about education to obtain a skill is stored, said method comprising:
a comparing step for comparing information about skills actually held by respective workers in an organization with information about a number of workers with skills required in said organization; and
an output step for outputting information about an education plan of the workers belonging to said organization based on the result of said comparing step and said information about education to obtain a skill,
wherein said comparing step and said output step are executed by said computer.

2. The skill matching information providing method according to claim 1, wherein information about a plural fields of skills actually held by respective workers in said organization and information about numbers of workers with respective skills required in said organization are compared at said comparing step.

3. The skill matching information providing method according to claim 2, wherein said information about numbers of workers with respective skills required in an organization is found by comparing information about skills actually held by workers in said organization with information about skills actually held by workers in another organization.

4. A skill matching information providing method for providing information about candidates in a second organization to be transferred to a first organization, said method comprising:
a comparing step for comparing information about skills actually held by respective workers in said first organization with information about a number of workers with skills required in said first organization; and
an output step for outputting information about candidates to be transferred from a second organization to said first organization based on the result of said comparing step and information about skills actually held by respective workers in said second organization,
wherein said comparing step and said output step are executed by a computer.

5. The skill matching information providing method according to claim 4, wherein information about a plural fields of skills actually held by respective workers in said first organization and information about numbers of workers with respective skills required in said first organization are compared at said comparing step.

6. The skill matching information providing method according to claim 5, wherein said information about numbers of workers with respective skills required in an organization is found by comparing information about skills actually held by workers in said organization with information about skills actually held by workers in another organization.

7. The skill matching information providing method according to claim 4, wherein said candidates are extracted from workers in said second organization except the workers allocated with transfer prohibited information, which is stored in a storage of said computer, in said output step.

8. A skill matching information providing method comprising:
a comparing step comparing information about skills actually held by respective workers in a first organization with information about a number of workers with skills required in said first organization;
a selecting step for selecting candidates to be educated to acquire the skills from workers in said first organization and a second organization based on the result of said comparing step and information about skills actually held by respective workers in said first and second organizations; and
an output step for outputting information with respect to personnel transfer to said first organization and an education plan that is related to said candidates belonging to said second organization,
wherein said comparing step, said selecting step and said output step are executed by a computer.

9. A skill matching information providing program to be read by a computer that includes a storage in which information about education to obtain a skill is stored, said program causing the computer to execute processes comprising:
a comparing step comparing information about skills actually held by respective workers in an organization with information about a number of workers with skills required in said organization; and
an output step for outputting information about an education plan of the workers belonging to said organization based on the result of said comparing step and said information about education to obtain a skill.

10. A skill matching information providing program read by a computer to extract candidates in a second organization to be transferred to a first organization, said program causing the computer to execute processes comprising:
a comparing step for comparing information about skills actually held by respective workers in said first organization with information about a number of workers with skills required in said first organization; and
an output step for outputting information about candidates to be transferred from said second organization to said first organization based on the result of said comparing step and information about skills held by respective workers in said second organization.

11. A skill matching information providing program read by a computer to execute processes comprising:
a comparing step comparing information about skills actually held by respective workers in a first organization with information about a number of workers with skills required in said first organization;
a selecting step for selecting candidates to be educated to acquire skills from workers in said first organization and a second organization based on the result of said comparing step and information about skills actually held by respective workers in said first and second organizations; and
an output step for outputting information with respect to personnel transfer to said first organization and an education plan that are related to said candidates belonging to said second organization.

12. A skill matching information providing system comprising:
a first memory portion in which information about skills actually held by respective workers in an organization is stored;
a second memory portion in which information about a number of workers with skill required in said organization is stored;
a third memory portion in which information about education to obtain a skill is stored;
a comparing portion for comparing information stored in said first memory portion with information stored in said second memory portion; and
an output portion for outputting information of an education plan of the workers belonging to said organization based on the result of said comparing step and information stored in said third memory portion.

13. A skill matching information providing system for extracting candidates in a second organization to be transferred to a first organization, said system comprising:
a first memory portion in which information about skills actually held by respective workers in said first organization is stored;
a second memory portion in which information about skills actually held by respective workers in said second organization is stored;
a third memory portion in which information about a number of workers with skills required in said first organization is stored;
a comparing portion for comparing information stored in said first memory portion with information stored in said third memory portion; and
an output portion for outputting information of candidates to be transferred from said second organization to said first organization based on the result from said comparing portion and information stored in said second memory portion.

14. A skill matching information providing system comprising:
a first memory portion in which information about skills actually held by respective workers in a first organization is stored;
a second memory portion in which information about skills actually held by respective workers in a second organization is stored;
a third memory portion in which information about a number of workers with skills required in said first organization is stored;
a comparing portion for comparing information stored in said first memory portion with information stored in said third memory portion;
a selecting portion for selecting candidates to be educated to acquire skills from workers in said first and second organizations based on the result from said comparing portion and information stored in said first and second memory portions; and
an output step for outputting information with respect to personnel transfer to said first organization and an education plan that are related to said candidates belonging to said second organization.
